(19) United States
(12) Patent Application Publication
(10) Pub. No.: US 2019/0196074 A1
(43) Pub. Date: Jun. 27, 2019

(54) Microscopy Safety Dome

(71) Applicant: The University of Vermont and State Agricultural College, Burlington, VT (US)

(72) Inventor: Guy G. Kennedy, Underhill Center, VT (US)

(73) Assignee: The University of Vermont and State Agricultural College, Burlington, VT (US)

(21) Appl. No.: 16/289,008

(22) Filed: Feb. 28, 2019

Related U.S. Application Data
(63) Continuation-in-part of application No. 15/350,074, filed on Nov. 13, 2016.

(51) Int. Cl. G02B 5/28; G02B 21/28; G02B 21/30

(52) U.S. Cl. CPC G02B 5/285; G02B 21/30; G02B 21/28

(57) ABSTRACT

A laser light containment dome providing increased safety to microscopy users while allowing the microscopy instrument to be used in an effective and efficient manner is provided. The laser light containment dome includes a hemisphere or dome shaped enclosure that prevents dangerous intensities of laser light from exiting an objective lens and or microscopy sample holder while still allowing the user to witness and measure the direction of laser light in three dimensions.

### CROSS-REFERENCE TO RELATED APPLICATIONS

The present application is a continuation-in-part and is related to, and claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. patent application Ser. No. 15/350,074, entitled “Microscopy Safety Dome”, naming Dr. Guy G. Kennedy as inventor, filed 12 Nov. 2016.

### BACKGROUND

### 1. Field of Use

The invention relates to microscope slides and more particularly to domed microscope slide covers having optical characteristics.

### 2. Description of Prior Art (Background)

Development in microscopy has required the incorporation of lasers and other bright light sources for specimen illumination. The power, wavelength, and direction of these lasers and other light sources vary dramatically depending on the application. These sources can range in wavelength from Ultraviolet to the Infrared. Exposure to this light can be hazardous to skin and particularly eyes.

Recently “through the lens” (TIR) microscopy has very popular. With this technology laser light utilized to interrogate a sample of interest propagates through an objective lens onto a slide containing the sample of interest. Reflected or refracted laser light from the sample is directed back into the objective lens, and back into the microscope for analysis. The sample of interest may be any solid or liquid sample or both.

In TIR, Microscopy, the laser alignment is routinely adjusted for clean TIR. When adjusted for pure TIR, the reflected laser light from the sample is directed back into the objective lens, and back into the microscope. Unfortunately, numerous conditions in which the laser light can exit the objective lens, and or specimen sample, and intrude upon the operator space. This laser light creates a hazard particularly for the operator eyes.

For example, conditions in which laser light can impinge upon the operator include: an air bubble in liquid meniscus acting as a redirecting lens, thus redirecting the laser beam towards the operator routine adjustments tuning the TIR critical angle; using the laser for “Dirty TIR”; and, using the laser for “Farfield” illumination.

Some commercial laser microscopy systems may have an opaque enclosure to cover the objective lens and or the sample area. These covers may include a safety interlock system to prevent the system for being operated without the cover in place. The weakness of this design is the inability to see where the laser light is being directed. This makes it necessary to remove or bypass the safety feature in order to make critical visual adjustment. These adjustments are frequently accomplished while observing the beam impinging upon the local environment such as the walls or ceiling. While doing this at low laser powers may be risky, higher powers can be very dangerous.

New techniques in imaging have required significantly higher power lasers. These techniques include, but are not exclusive to: STORM Microscopy PALM Microscopy Confocal Microscopy, Two Photon Microscopy, and Light Sheet Microscopy. These high-power techniques increase the risk of direct laser exposure to the user and others with laser light of high intensity is reflected or refracted from a variety of surfaces.

Concave slides and domed covers are not unknown in the art. For example, U.S. Pat. No. 5,527,510 describes a compliant cover having a degree of concavity chosen to define a volume of regent contained between a cover and a slide. U.S. Pat. No. 3,941,567 includes a hermetic chamber adjacent to a slide. U.S. Pat. No. 3,580,658 describes a gas cooled microscope slide having built-in cooling chambers formed by a through opening in the slide body. U.S. Patent Application 20150153553 describes a fluorescence observation device with an opaque light shielding partition dome coupled to a base to define a light shielding chamber with a transparent observation aperture.

Yet, the prior art is silent with regards to a transparent safety dome suitable for viewing and adjusting the interrogating laser light in real time, i.e., without need to stop, remove a cover, adjusting the laser, replace the cover, repeat. Thus, there is a need for a cover which allows an operator to se or detect the presence and direction of a laser beam while protecting the operator from exposure to the laser beam.

### BRIEF SUMMARY

The foregoing and other problems are overcome, and other advantages are realized, in accordance with the presently preferred embodiments of these teachings.

In accordance with one embodiment of the present invention a light containment apparatus providing increased safety to microscopy operators while allowing the instrument to be used in an effective and efficient manner is provided. The apparatus includes a transparent hemisphere or dome shaped enclosure that prevents unwanted or dangerous intensities of laser light from exiting an objective lens and or microscopy sample holder while still allowing the user to observe the laser light direction. Light sources may include laser light, LED light, Gas Discharge; Tungten, Mercury Vapor, and/or Mercury Halide.

In accordance with another embodiment of the invention, a microscopy safety dome for protecting users from laser light for interrogating a sample held on a microscope stage is provided. The safety dome includes a hemispherical shell, wherein the hemispherical shell is transparent to visible light, and wherein the hemispherical shell includes an inner surface having an optical costing for blocking the laser light from passing through the hemispherical shell.

The invention is also directed towards a semi-transparent hemispherical shell for protecting users from laser light for interrogating a sample held on a microscope stage. The semi-transparent hemispherical shell is semi-transparent to visible light and includes an inner surface having an optical costing for blocking the laser light from passing through the semi-transparent hemispherical shell. The optical costing includes at least one thin film metal layer, wherein the thin film metal layer reflects laser light while allowing transmittance of the visible light through the semi-transparent hemispherical shell.

In accordance with another embodiment of the invention, a hemispherical shell for protecting users from laser light for interrogating a sample held on a microscope stage is provided. The hemispherical shell includes an inner surface coated with an optical coating for blocking the laser light from passing through the hemispherical shell. The optical coating comprises a plurality of thin film metal layers, wherein the thin film metal layers reflect laser light while allowing transmittance of the visible light. The plurality of thin film metal layers are interleaved with a plurality of dielectric layers for improving transmittance of the visible light through the semi-transparent hemispherical shell. The dielectric layers are composed of an oxide or dioxide material. The shell also includes an outer surface having reference marks for determining laser light x, y, and z angles of hemispherical shell incidence relative to the microscope stage.

### BRIEF DESCRIPTION OF THE DRAWINGS

The subject matter which is regarded u the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of the prior art illustrating the risk to a user without a Microscopy Safety Dome as described herein;

FIG. 2 is a pictorial illustration of one embodiment of the microscopy safety dome described herein;

FIG. 3 is an operational schematic illustration of the microscopy safety dome in accordance with the invention shown in FIG. 2;

FIG. 3A is an illustration of the interleaved coating in accordance with the invention shown in FIG. 2 and FIG. 3;

FIG. 4 is an operational schematic illustration of an alternate gas embodiment of the microscopy safety dome in accordance with the invention shown in FIG. 2;

FIG. 5 is an operational schematic illustration of an alternate light scattered embodiment of the microscopy safety dome in accordance with the invention shown in FIG. 2;

FIG. 6 is an operational schematic illustration of an alternate attenuated light scattered or transmitted embodiment of the microscopy safety dome in accordance with the invention shown in FIG. 2;

FIG. 7 is an operational schematic illustration of an alternate thermo-electric embodiment of the microscopy safety dome in accordance with the invention shown in FIG. 2;

FIG. 8 is an operational schematic illustration of an alternate temperature controlled embodiment of the microscopy safety dome in accordance with the invention shown in FIG. 2;

FIG. 9 is an operational schematic illustration of an alternate fluorescent or phosphorescent emission embodiment of the microscopy safety dome in accordance with the invention shown in FIG. 2;

FIG. 10 is a operational schematic illustration of an alternate photo-electric position sensor array embodiment of the microscopy safety dome in accordance with the invention shown in FIG. 2;

FIG. 11 is an operational schematic illustration of an alternate safety interlock embodiment of the microscopy safety dome in accordance with the invention shown in FIG. 2;

FIG. 12 is an operational schematic illustration of an alternate Petrie Dish embodiment of the microscopy safety dome in accordance with the invention shown in FIG. 2;

FIG. 13 is an operational schematic illustration of an alternate integrated Petrie Dish embodiment of the microscopy safety dome in accordance with the invention shown in FIG. 2;

FIG. 14 is an operational schematic illustration of an alternate Petrie Dish embodiment of the microscopy safety dome with selective optical filtering and blocking in accordance with the invention shown in FIG. 2; and

FIG. 15 is an operational schematic illustration of an alternate Petrie Dish embodiment of the microscopy safety dome with an optical window accordance with the invention shown in FIG. 2.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic

A sample holder or receptacle may be any suitable sample holder or receptacle such as, for example, a sample slide or Petrie Dish; and

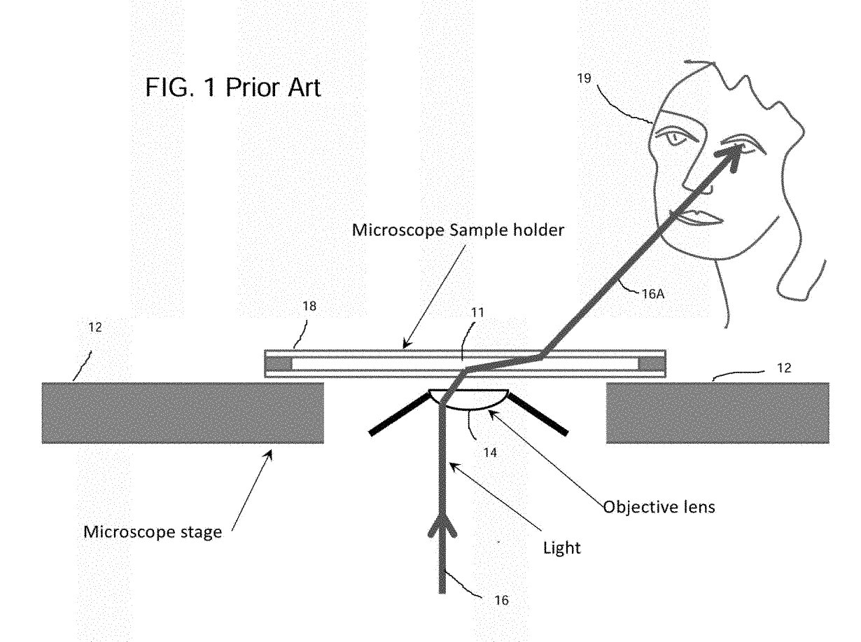

Referring now to FIG. 1 of the drawings, there is shown 1 an illustration of the prior art illustrating the risk to a user without a Microscopy Safety Dome as described herein. Illuminating light 16 travels through objective lens 14 and illuminates sample II held by sample holder 18. Sample holder is supported by microscope stage 12. It will be understood that light 16 may include laser light or any other type of light source such as, for example: LED light, Gas Discharge; Tungsten, Mercury Vapor, and/or Mercury Halide generated light. Light 16A is that portion of light 16 which poses a high risk of injury to user 19.

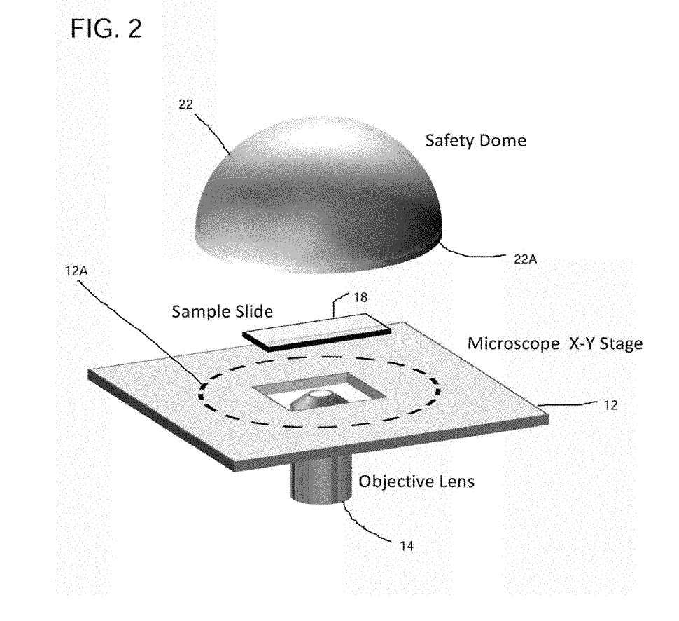

Referring now to FIG. 2 there is shown a pictorial illustration of one embodiment of the microscopy safety dome described herein. Safety dome 22 is adapted to couple to microscope stage 12 and is of sufficient diameter to enclose sample holder 18. Safety dome 22 may be coupled to microscope stage 12 via dome mating surface 22A and stage mating surface 12A. It will be appreciated that any suitable coupling may be used. Suitable coupling may include, for example, magnetic coupling, latch coupling, twist and lock coupling, or weighted coupling.

Still referring to FIG. 2 safety dome 22 may be constructed of any suitable material exhibiting optical characteristics such as fluorescent phosphorescent opaque and or translucent.

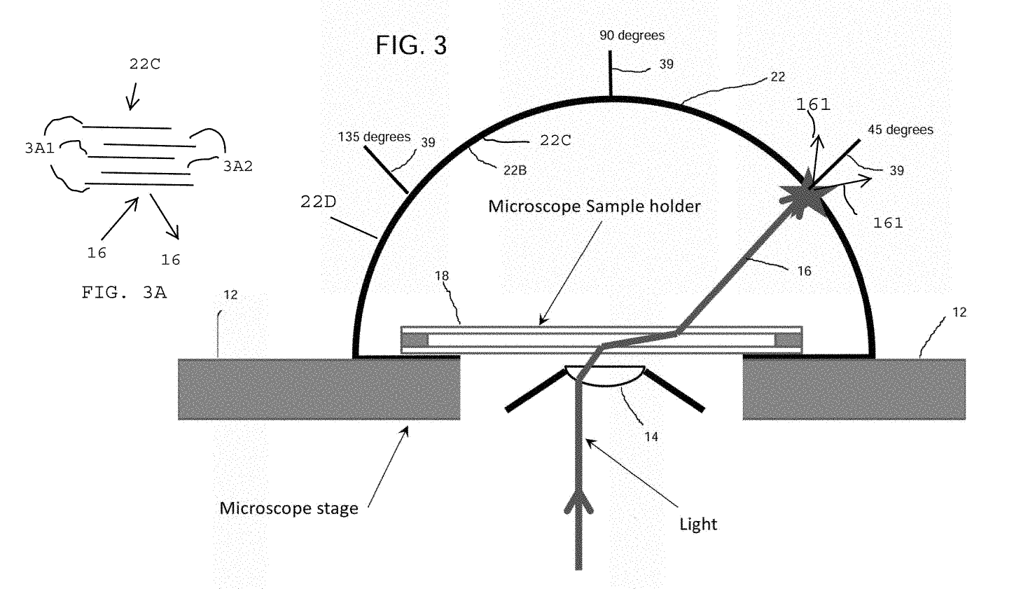

Referring also to FIG. 3 there is shown an operational schematic illustration of the microscopy safety dome or shell in accordance with the invention shown in FIG. 2. In this embodiment safety dome 22 is exhibiting laser blocking, i.e., not letting laser light 16 pas through the dome 22. Safety dome 22 may be constructed of optical glass or plastic and may be coated on the interior 22B of dome 22 with desired material 22C to exhibit desired optical characteristics, e.g., blocking, scattering, absorption.

Still referring to FIG. 3 and FIG. 3A, in an alternate embodiment film 22C may be a film having both high laser light reflectivity and high visible light transparency. Film 22C may include one or more thin film metal layers 3A1 for reflecting the laser light while allowing transmittance of the visible light. The thin film metal layers may be interleaved with dielectric layers for improving transmittance of the visible light 161. The dielectric layer may include titanium dioxide, zinc oxide, aluminum oxide, zirconium oxide, silicon dioxide, tin oxide, tin-doped indium oxide (ITO), and/or antimony-doped tin oxide (ATO).

Still referring to FIG. 3 safety dome 22 may include graduated scale markers or rings 39 on outer surface 22D used to reference laser light 16 impact angles and quadrants to determine x, y, and z angles of incidence relative to microscope stage 12. In addition, dome 22 may incorporate sample slide 18 or be rigidly affixed to sample slide 18 or a sample slide housing to form a one-piece unit. Rigidly affixing the dome 22 to the sample slide 18 or sample slide housing may be any suitable means such as mechanical, e.g., slots, mating tabs, or adhesives.

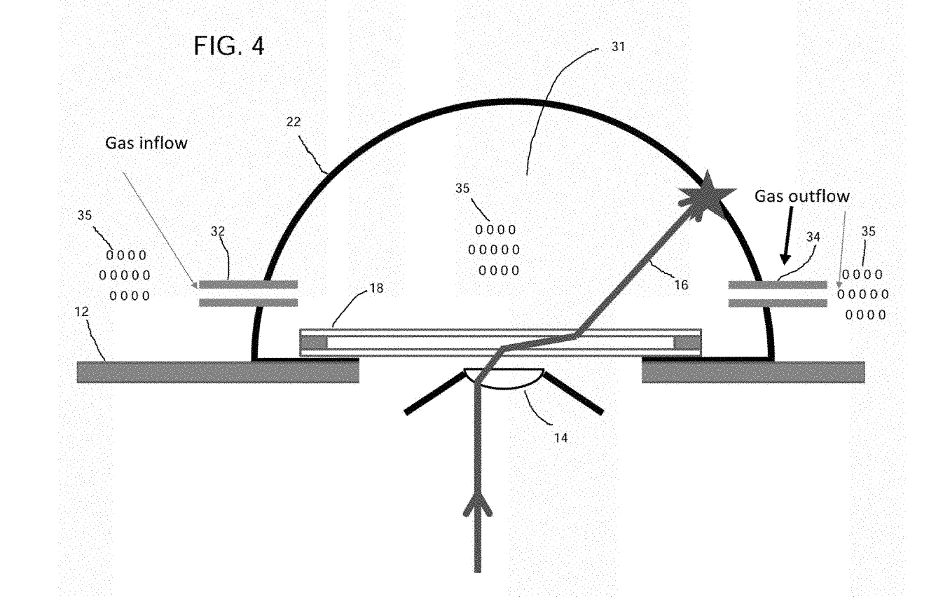

Referring also to FIG. 4 there is shown an operational schematic illustration of an alternate gas embodiment of the microscopy safety dome in accordance with the invention shown in FIG. 2 and FIG. 3. It will be appreciated that the problems associated with observing heat sensitive specimens, e.g., live specimens are overcome by the present invention through the provision of gas inflow port 32, cooling chamber 31, and gas outflow port 34. A gas 35 is imported through gas inflow port 32 into chamber 31 while the slide 18 is in the microscope (not shown) to cool the slide 18 and thereby prolong the life of a specimen (not shown) while under observation and subsequently exported through gas outflow port 34. Gas 35 may be any suitable gas coolant. It will be appreciated that gas 35 flow may be continuous or intermittent.

Still referring to FIG. 4, it will also be appreciated that gas 35 may be a suitable gas for interacting with laser light 16 providing a visual marker or tracing of the laser light 16 as it passes through gas 35.

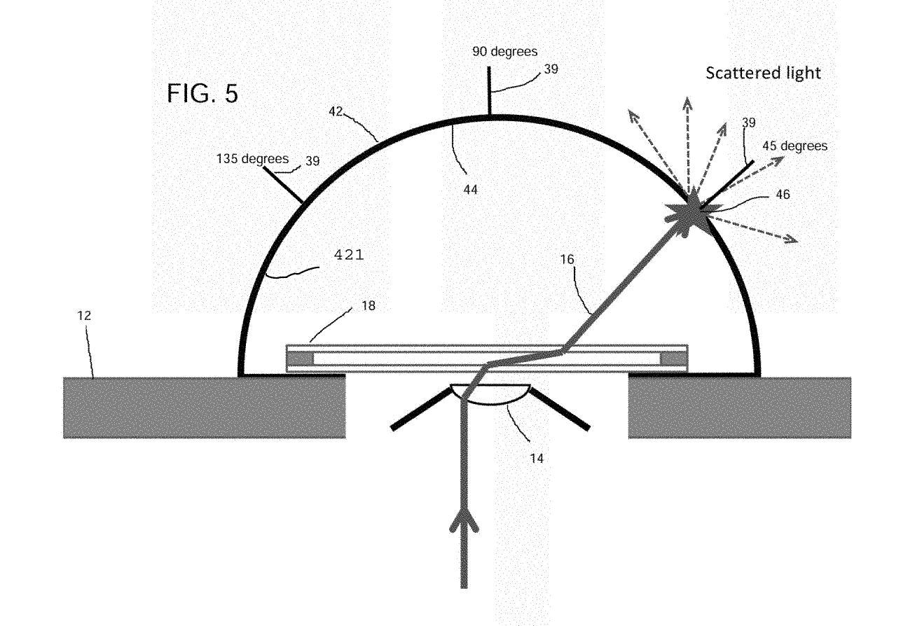

Referring also to FIG. 5, there is shown is an operational schematic illustration of an alternate light scattered embodiment of the microscopy safety dome in accordance with the invention shown in FIG. 2. In this embodiment shell 42 may be any suitable transparent or semi-transparent material such as, for example, optical glass, plexiglass, or a clear plastic. In addition, shell 42, having an inner surface 421 may be coated with an optical solution 44 to achieve the desired scattering 46 of laser light 16. It will also be appreciated that shell 42 may be any suitable material achieving the desired optical effect, such as, for example, scattering. For example, shell 42 may comprise a glass or plastic shell embedded with light scattering particles, e.g., air bubbles, glass, metal, or plastic spheres or particles. It will also be appreciated that the embedded light scatters may also comprise fluorescent or phosphorescent light characteristics. It will be understood that scattering laser light 16 decreases the intensity and power of laser light 16 to safer levels for operators.

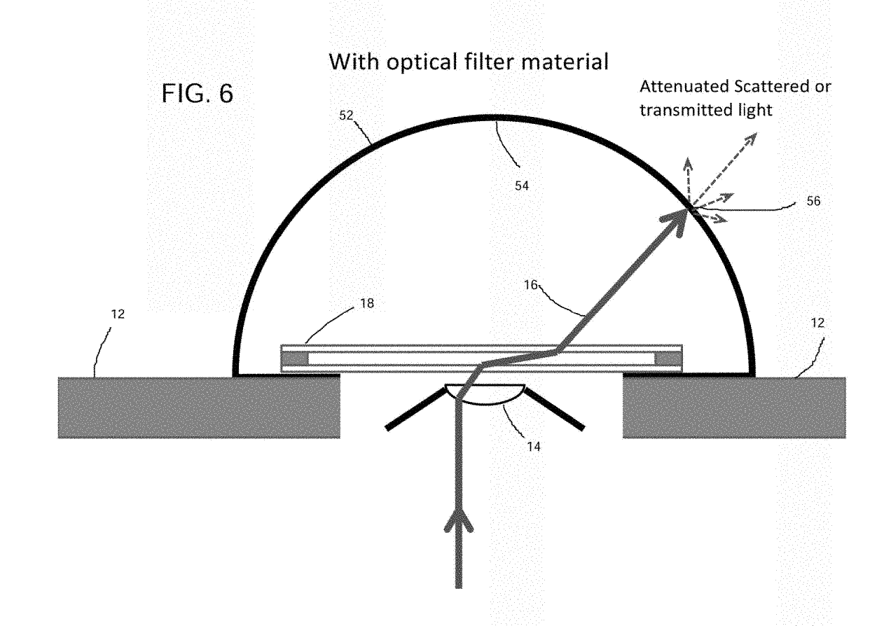

Referring also to FIG. 6 there is shown is an operational schematic illustration of an alternate attenuated light scattered or transmitted embodiment of the microscopy safety dome in accordance with the invention shown in FIG. 2. In this embodiment shell 52 may be any suitable transparent or semi-transparent material such as, for example, optical glass or a clear plastic. In addition, shell 52 may be coated with an optical solution 54 to achieve the desired attenuated scattering 56. It will be understood that scattering and attenuating laser light 16 decreases the intensity and power of laser light 16 to safer levels for operators.

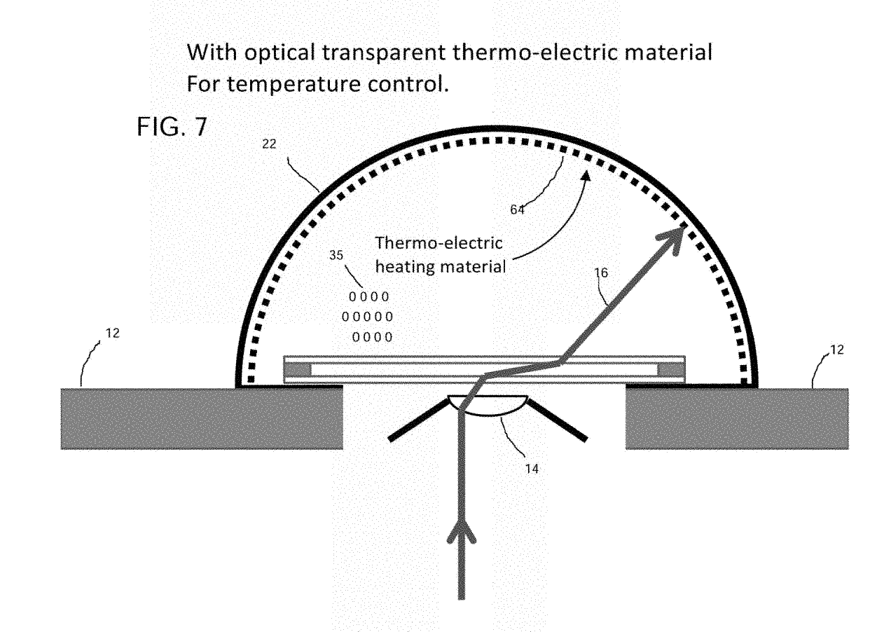

Referring also to FIG. 7 there is shown an operational schematic illustration of an alternate thermo-electric embodiment of the microscopy safety dome in accordance with the invention shown in FIG. 2. In this embodiment shell 22 may be any suitable transparent or semi-transparent material such as, for example, optical glass or a clear plastic. Shell 22 may be coated with a thermo-electric light emissive material 64 reactive to laser light 16. Thus, if shell 22 is suitably transparent, when laser light 16 strikes material 64 a light emission occurs and a user may visually determine where the laser light 16 is impacting shell 22.

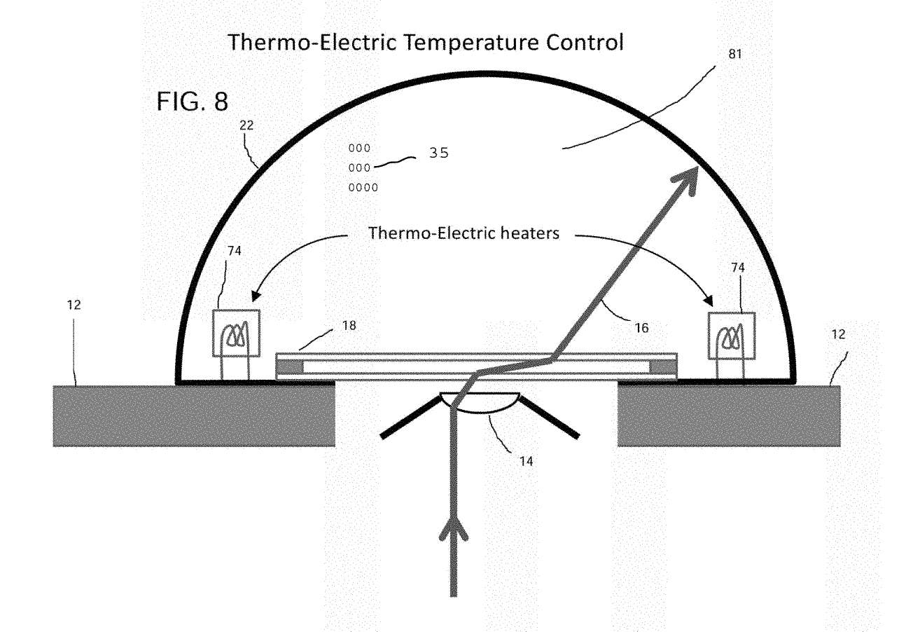

Referring also to FIG. 8 there is shown a operational schematic illustration of an alternate temperature-controlled embodiment of the microscopy safety dome in accordance with the invention shown in FIG. 2. Thermo-electric heaters 74 heat the enclosed chamber 81 to a desired temperature to control the optical characteristics (dependent on temperature and humidity) of the gas 35 within chamber 81 and heat dependencies of a sample (not shown) contained within slide 18.

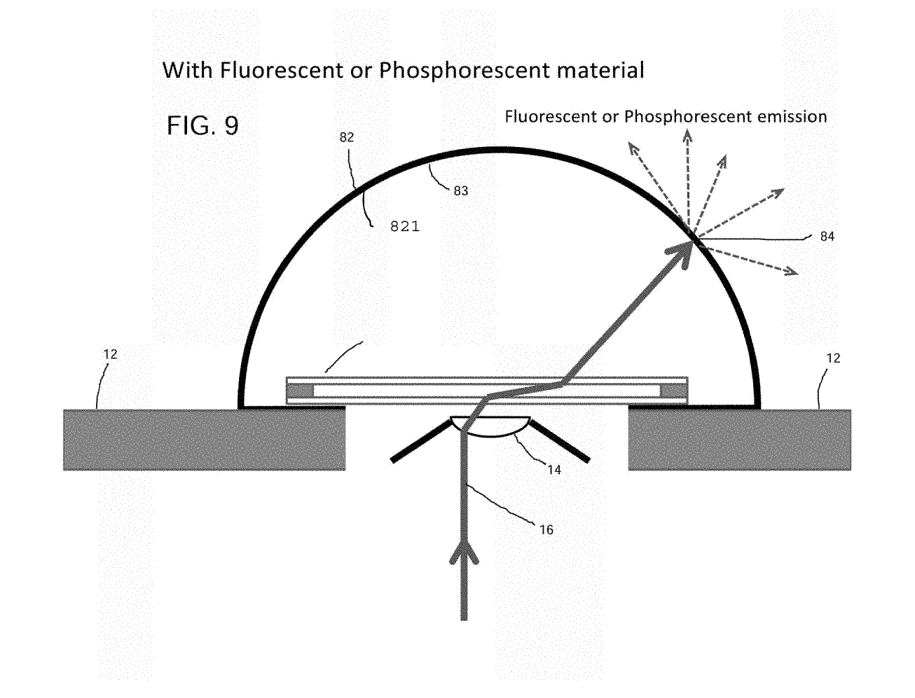

Referring also to FIG. 9 there is shown an operational schematic illustration of an alternate fluorescent or phosphorescent emission embodiment of the microscopy safety dome in accordance with the invention shown in FIG. 2. In this embodiment shell 82 may be any suitable transparent or semi-transparent material such as, for example, optical glass or a clear plastic. In addition, interior shell 821 may be coated with an optical solution 83 to achieve the desired fluorescent or phosphorescent emission 84 through shell 82.

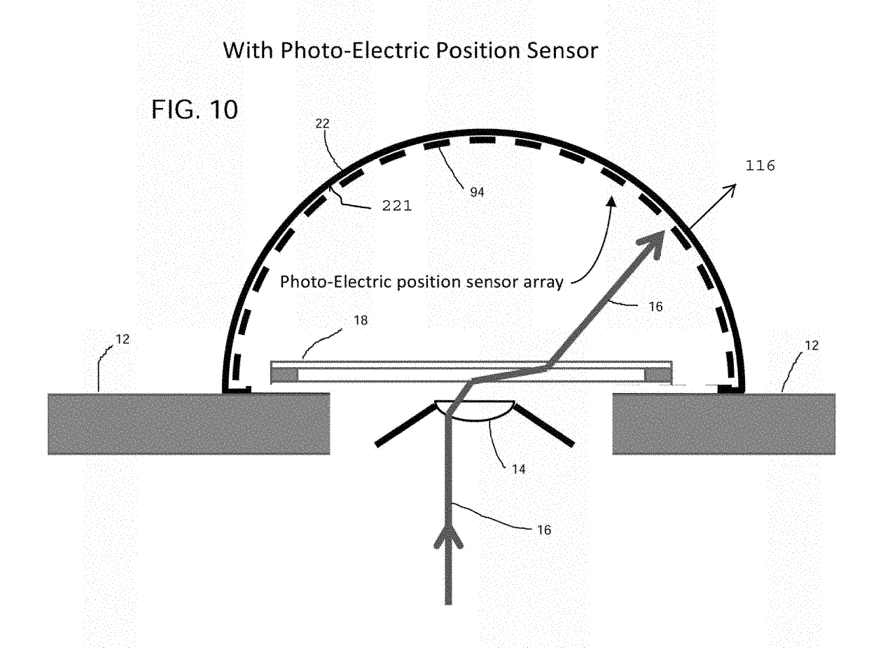

Referring also to FIG. 10 there is shown an operational schematic illustration of an alternate photo-electric position sensor array embodiment of the microscopy safety dome in accordance with the invention shown in FIG. 2. In this embodiment shell 22 may be any suitable opaque, transparent or semi-transparent material such as, for example, optical glass or a clear plastic. In addition, interior shell 221 may include a photoelectric position sensor array 94 reactive to laser light 16. photo-electric position sensor array 94 transmits a visible light signal 116 through shell 22 as light 16 interacts with photo-electric position sensor array 94 such that a user may visually determine where the laser light 16 impacts shell 22.

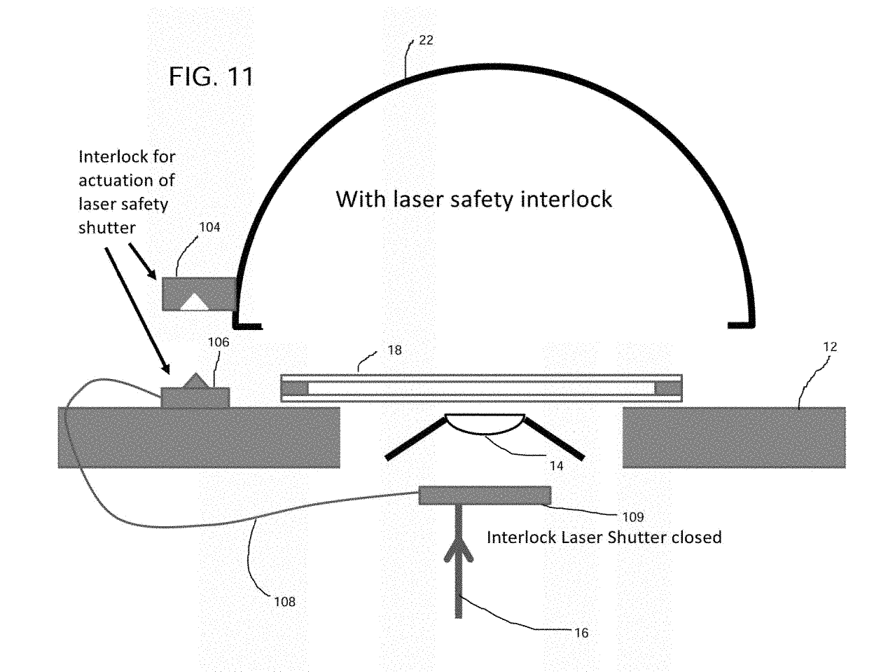

Referring also to FIG. 11 there is shown an operational schematic illustration of an alternate safety interlock embodiment of the microscopy safety dome 22 in accordance with the invention shown and described herein. In this embodiment interlock part 104 attached to the dome 22 must interact with interlock part 106 before interlock shutter 109 opens to allow light 16 to pass through objective 14. Shutter control line 108 senses when interlock parts 104 and 106 are mated or otherwise connected to allow safe operation. It will be understood that shutter control line 108 may be any suitable mechanical, electrical, or wireless control line.

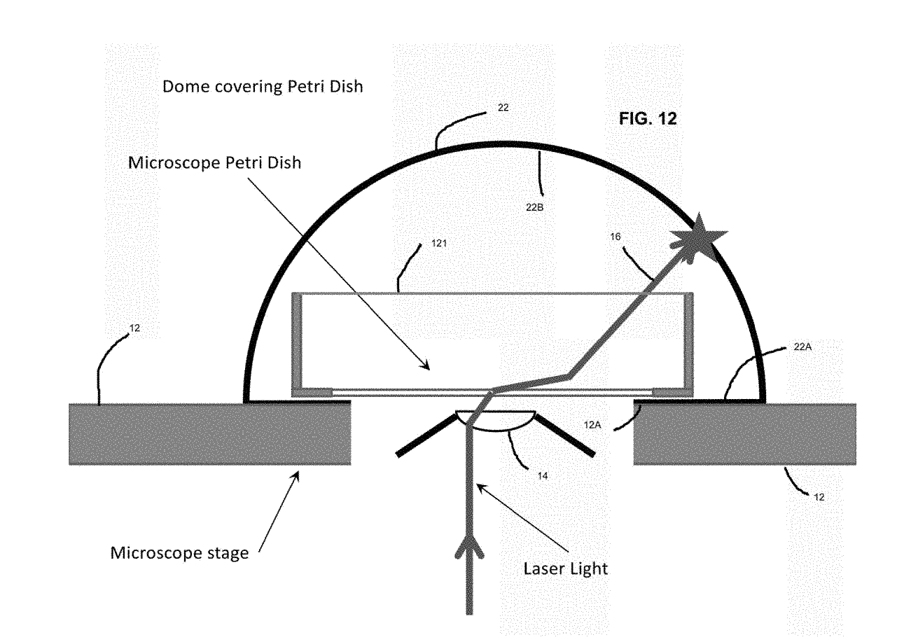

Referring also to FIG. 12 there is shown a pictorial illustration of one embodiment of the microscopy safety dome described herein. Safety dome 22 is adapted to couple to microscope stage 12 and is of sufficient diameter to enclose Petrie Dish 121. Safety dome 22 may be coupled to microscope stage 12 via dome mating surface 22A and stage mating surface 12A. It will be appreciated that any suitable coupling may be used. Suitable coupling may include, for example, magnetic coupling, latch coupling, twist and lock coupling, or weighted coupling.

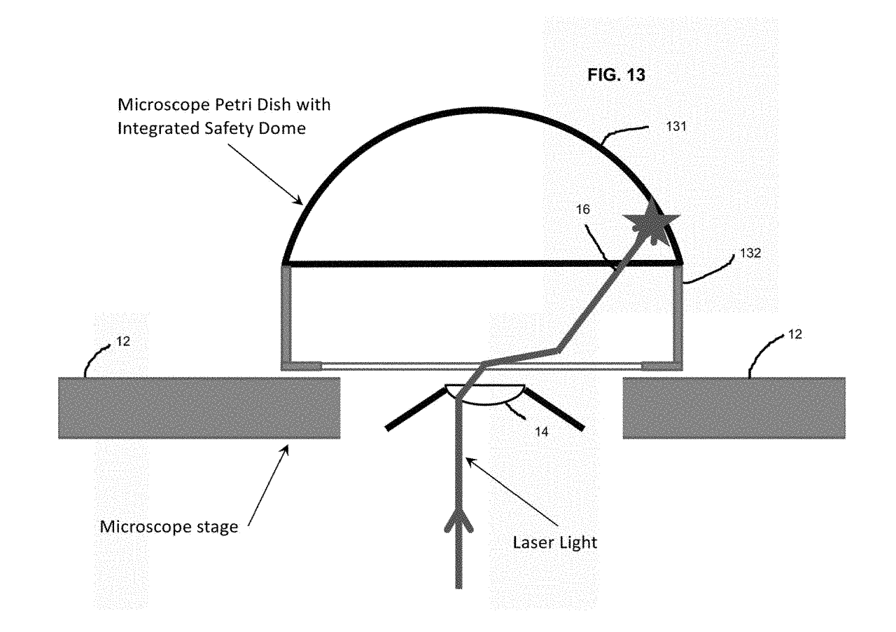

Referring now to FIG. 13 there is shown a pictorial illustration of one embodiment of the microscopy safety dome described herein. Safety dome 131 is adapted to couple to Petrie Dish 132 and is of sufficient diameter to enclose Petrie Dish 131. It will be appreciated that any suitable coupling may be used. Suitable coupling may include, for example, magnetic coupling, latch coupling, twist and lock coupling, or weighted coupling. In addition, the safety dome 131 may be removeable from Petrie Dish 132 or may be permanently affixed to Petrie Dish 132 with suitable adhesives and/or mechanical means.

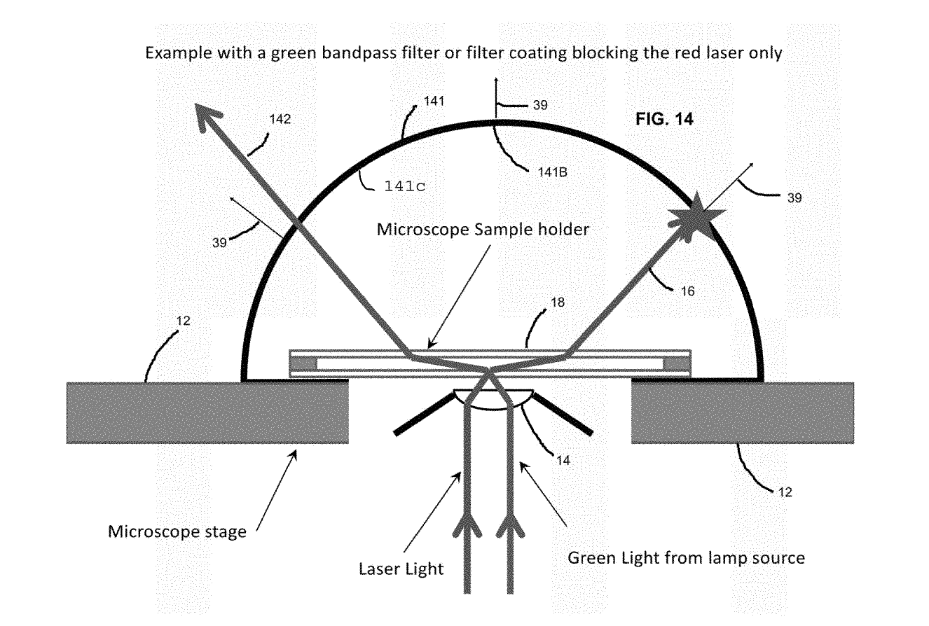

Referring also to FIG. 14 there is shown an operational schematic illustration for an alternate embodiment of the microscopy safety dome or shed in accordance with the invention shown and described herein. In this embodiment safety dome 141 is exhibiting selective optical characteristic. Safety dome 141 may include material such as optical glass, plastic, or metal and may be coated on, or adjacent to, the interior 141B of dome 141 with desired material costing 141C to exhibit desired optical characteristics. Selective optical characteristics employed by safety dome 141 may include wavelength band pass, wavelength band blocking, narrow wavelength band pass or blocking and/or wide wavelength band pass or blocking. For example, FIG. 14 shows safety dome 141 allowing light from lamp source 142 to pass through safety dome 141 while blocking laser light 16. It will be appreciated that the selective optical characteristics may be a feature of the safety dome 141 material and/or a feature of the material coating on interior 141B.

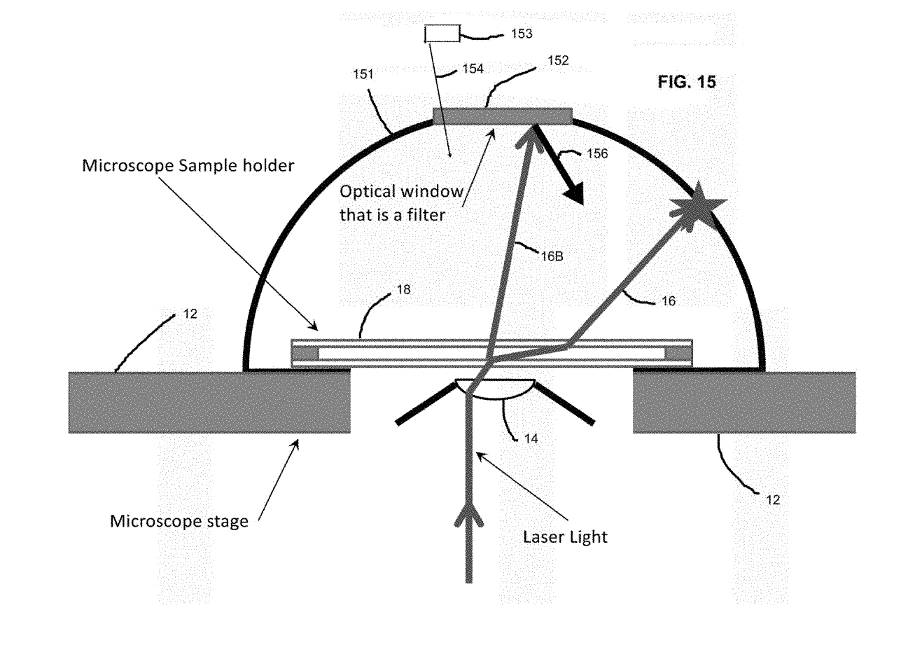

Referring also to FIG. 15 there is shown an operational schematic illustration for n alternate embodiment of the microscopy safety dome 151 or shell in accordance with the invention shown in FIG. 2. In this embodiment safety dome 151 incorporates optical window 152 allowing band pass for light of specific wavelengths to enter into the dome from outside allowing brightfield illumination 154 from a brightfield light source 153. The filter 152 may be absorptive to laser light 16B and/or may be reflective to laser light 16B as illustrated by reflected laser light 156.

It should be understood that the foregoing description is only illustrative of the invention. Thus, various alternatives and modifications can be devised by those skilled in the art without departing from the invention. For example, the interlock feature shown in FIG. 11 can be combined with any of the other features shown in FIG. 2 through FIG. 15.

In addition, materials used for shells (e.g., 22 in FIG. 2) may be fluorescent, phosphorescent opaque and or translucent. The invention described herein may be incorporated to microscope design, or as an aftermarket kit or accessory. It will be appreciated that with diffusive, and or translucent material as described herein, a user can directly witness the location and size of a light beam (e.g., 16 in FIG. 2) exiting the sample area (e.g. slide 18 in FIG. 2). Materials for shell (e.g., 22 in FIG. 2) include construction containing or fabricated from plastics, ceramics, glass, silica, and/or silicone. The reflective coatings may be constructed or fabricated from oxides, dioxides, and fluorescent dye, lanthanides, quantum dots, evaporated optical coatings, spray coatings, and/or light absorbing coatings. Accordingly, the present invention is intended to embrace all such alternatives, modifications and variances that fall within the scope of the appended claims.

1. A microscopy safety dome for protecting users from laser light for interrogating a sample held on a microscope stage, the safety dome comprising:
a safety dome, the safety dome comprising:
a hemispherical shell, wherein the hemispherical shell is transparent to visible light, and wherein the hemispherical shell comprises;
an inner surface, wherein the inner surface comprises:
an optical coating adjacent to the inner surface for blocking the laser light from passing through the hemispherical shell.

2. The microscopy safety dome as in claim 1 wherein the optical coating comprises at least one thin film metal layer, wherein the thin film metal layer reflects laser light while allowing transmittance of the visible light through the transparent hemispherical shell.

3. The microscopy safety dome as in claim 1 wherein the optical coating comprises a plurality of thin film metal layers, wherein the thin film metal layers reflect laser light while allowing transmittance of the visible light, and wherein the plurality of thin film metal layers are interleaved with a plurality of dielectric layers for improving transmittance of the visible light through the transparent hemispherical shell.

4. The microscopy safety dome as in claim 2 further comprising reference marks for determining laser light x, y, and z angles of hemispherical shell incidence relative to the microscope stage.

5. The microscopy safety dome as in claim 1 wherein the transparent hemispherical shell further comprises
a gas inflow port for importing a cooling gas;
a gas outflow port for exporting the cooling gas; and
wherein the cooling gas interacts with the laser light to provide a trace of the laser light through the cooling gas.

6. The microscopy safety dome as in claim 1 wherein the transparent hemispherical shell further comprises a thermo-electric heating material adjacent to the inner surface.

7. The microscopy safety dome as in claim 1 further comprising at least one thermo-electric heater.

8. The microscopy safety dome as in claim 1 wherein the transparent hemispherical shell further comprises a photo electric position sensor array adjacent to the inner surface.

9. The microscopy safety dome as in claim 1 wherein the transparent hemispherical shell further comprises an optical window, wherein the optical window is transparent to a brightfield light source and reflective to the laser light.

10. A semi-transparent hemispherical shell for protecting users from laser light for interrogating a sample held on a microscope stage, the semi-transparent hemispherical shell comprising:
the semi-transparent hemispherical shell, wherein the hemispherical shell is semi-transparent to visible light, and wherein the semi-transparent hemispherical shell comprises an inner surface, wherein the inner surface comprises:
an optical coating adjacent to the inner surface for blocking the laser light from passing through the semi-transparent hemispherical shell, and wherein the optical coating comprises at least one thin film metal layer, wherein the thin film metal layer reflects laser light while allowing transmittance of the visible light through the semi-transparent hemispherical shell.

11. The semi-transparent hemispherical shell as in claim 10 wherein the optical coating comprises a plurality of thin film metal layers, wherein the thin film metal layers reflect laser light while allowing transmittance of the visible light, and wherein the plurality of thin film metal layers are interleaved with a plurality of dielectric layers for improving transmittance of the visible light through the semi-transparent hemispherical shell.

12. The semi-transparent hemispherical shell as in claim 11 wherein the dielectric comprises an oxide.

13. The semi-transparent hemispherical shell as in claim 11 wherein the dielectric comprises a dioxide.

14. The semi-transparent hemispherical shell as in claim 10 wherein the semi-transparent hemispherical shell further comprises an optical window, wherein the optical window is transparent to a brightfield light source and reflective to the laser light.

15. The semi-transparent hemispherical shell as in claim 10 wherein the semi-transparent hemispherical shell further comprises
a gas inflow port for importing a cooling gas;
a gas outflow port for exporting the cooling gas; and
wherein the cooling gas is reactable with the laser light to provide a trace of the laser light through the cooling gas.

16. The semi-transparent hemispherical shell as in claim 10 further comprising reference marks for determining laser light x, y, and z angles of semi-transparent hemispherical shell incidence relative to the microscope stage.

17. A hemispherical shell for protecting users from laser light for interrogating a sample held on a microscope stage, the hemispherical shell comprising:
an inner surface, wherein the inner surface comprises:
an optical coating adjacent to the inner surface for blocking the laser light from passing through the hemispherical shell, and wherein the optical coating comprises a plurality of thin film metal layers, wherein the thin film metal layers reflect laser light while allowing transmittance of the visible light, and wherein the plurality of thin film metal layers are interleaved with a plurality of dielectric layers for improving transmittance of the visible light through the semi-transparent hemispherical shell; and
an outer surface, wherein the outer surface comprises reference marks for determining laser light x, y, and z angles of hemispherical shell incidence relative to the microscope stage.

18. The semi-transparent hemispherical shell as in claim 17 wherein the dielectric comprises an oxide.

19. The semi-transparent hemispherical shell as in claim 17 wherein the dielectric comprises a dioxide.

20. The hemispherical shell as in claim 17 wherein the hemispherical shell further comprises an optical window, wherein the optical window is transparent to a brightfield light source and reflective to the laser light.
